(19) United States
(12) Patent Application Publication
(10) Pub. No.: US 2022/0047047 A1
(43) Pub. Date: Feb. 17, 2022

(54) JEWELRY DEVICES, SYSTEMS AND METHODS

(71) Applicant: CAPSUL INC., El Segundo, CA (US)

(72) Inventor: Tina W. Cheng, Los Angeles, CA (US)

(73) Assignee: CAPSUL INC., El Segundo, CA (US)

(21) Appl. No.: 17/399,192

(22) Filed: Aug. 11, 2021

Related U.S. Application Data
(60) Provisional application No. 63/064,745, filed on Aug. 12, 2020.

(51) Int. Cl. A44C 15/00; G06F 16/955; G06F 16/44; G06F 3/0481

(52) U.S. Cl. CPC A44C 15/0015; G06F 3/04812; G06F 16/44; G06F 16/955

(57) ABSTRACT

Devices are disclosed that provide a way to store and share memories. The devices include a digital memory code which can be scanned to retrieve the memory from an internet accessible location. The digital memory code can be a binary code which has a visual appearance of, for example, a pattern of long and short rectangles.

### CROSS-REFERENCE

This application claims the benefit of U.S. Provisional Application No. 63/064,745, filed Aug. 12, 2020, entitled Wearable Memory Retrieval Devices, Systems and Methods, which application is incorporated herein in its entirety by reference.

### BACKGROUND

Life is full of memories. However, some memories are more precious than others: a sweet 16, a first date, a proposal, a wedding, a graduation, or other milestones.

Memories can be shared by sending, for example, a photo, an audio clip, or a video link. In practice, sharing or accessing digital memories requires digging through endless amounts of digital data to find the one digital record that captures the moment. Over time, the process of sharing or accessing a memory becomes more difficult due to the amount of data that is sifted through. When you consider that 2.5 quintillion bytes of data are created each day at our current pace, and that number is only expected to accelerate with the growth of the Internet of Things (IoT), finding and retrieving a digital memory in a sea of digital data will only get harder.

What is needed is a way to store and share a memory in unique and easily retrievable way. What is also needed is a way to store and share the memory in a way that is visually appealing. Additionally, what is needed is a wearable device, such as a piece of jewelry that provides access to a digitally stored memory.

### SUMMARY

Disclosed are ways to store and share memories in unique and easily retrievable way. Also disclosed is a way to store and share memories in a way that is visually appealing. Also disclosed are wearable devices, such as jewelry that provide access to a digitally stored memory.

An aspect of the disclosure is directed to memory retrieval devices. Memory retrieval devices comprise: a device selected from the group comprising necklace, locket, bracelet, earrings, ring and keychain; and a unique scan-able internet directing code operable to link to a website or web page including a digital memory selected from: (i) photographic, (ii) video, and (iii) audio, wherein the unique scan-able internet directing code is converted into one or more patterns selected from one or more overlapping shapes, one or more vertical bars, one or more overlapping boxes, one or more overlapping rectangles, one or more overlapping pentagons, one or more overlapping hexagons, one or more overlapping octagons, one or more overlapping stars, one or more overlapping ovals, one or more overlapping circles, one or more overlapping triangles, and one or more waves (such as a soundwave, fingerprint or portion thereof), further wherein the one or more patterns is applied to, affixed to, molded in, or embossed on at least one surface of the device. Additionally, the unique scan-able internet directing code shapes can be linearly, curvedly, circularly or randomly oriented. The unique scan-able internet directing code corresponds to a binary code generated from the digital memory. In some configurations, the pattern can be selected by a user. The pattern can be one or more vertical bars, one or more overlapping boxes, one or more overlapping rectangles, one or more overlapping pentagons, one or more overlapping hexagons, one or more overlapping octagons, one or more overlapping stars, one or more overlapping ovals, one or more overlapping circles, one or more overlapping triangles. The overlapping shapes can have different heights in at least one dimension. A second unique scan-able internet directing code can be provided that links to a second website or web page including a second digital memory selected from: (i) photographic, (ii) video, and (iii) audio, wherein the second unique scan-able internet directing code is applied to, affixed to, molded in, or embossed on at least one surface of the device different than the surface of the first unique scan-able internet directing code and the second unique scan-able internet directing code is created for the second digital memory, further wherein the second unique scan-able internet directing code is converted into one or more second patterns selected from one or more vertical bars, one or more vertical boxes, one or more vertical rectangles, one or more vertical ovals, and one or more waves. The second pattern is linearly, curvedly, circularly or randomly oriented. The second unique scan-able internet directing code is a second binary code generated from the second digital memory. Additionally, the second pattern can be selected by a user.

Another aspect of the disclosure is directed to a memory retrieval method comprising: selecting one digital memory from: (i) photographic memories, (ii) video memories, and (iii) audio memories; creating a unique scan-able internet directing code for the one digital memory; converting the unique scan-able internet directing code into one or more patterns selected from one or more vertical bars, one or more vertical boxes, one or more vertical rectangles, one or more vertical ovals, and one or more waves; selecting a memory retrieval device from the group comprising necklace, locket, bracelet, earrings, ring and keychain; and applying the pattern to a surface of the memory retrieval device. The code can be obtained from the memory retrieval device using an internet connected electronic device. Additionally, the user can select the one or more patterns.

Still another aspect of the disclosure is directed to a memory retrieval device system comprising: a server computer coupled to a network executing stored instructions allowing the server to host a webpage, the server also having access to a database of stored memories accessible by the server; a digital memory; a unique scan-able internet directing code for the digital memory; a converter for transforming the unique scan-able internet directing code into one or more patterns selected from one or more vertical bars, one or more overlapping boxes, one or more overlapping rectangles, one or more overlapping pentagons, one or more overlapping hexagons, one or more overlapping octagons, one or more overlapping stars, one or more overlapping ovals, one or more overlapping circles, one or more overlapping triangles, and one or more waves; and a memory retrieval device having a pattern affixed thereto, wherein the stored instructions on the server allow a person with a memory retrieval device to retrieve the memory from the database using the pattern. The patterns can be are linearly, curvedly, circularly or randomly oriented. Additionally, the unique scan-able internet directing code is a binary code generated from the digital memory. In some methods, the pattern is selected by a user.

Yet another aspect of the disclosure is directed to a memory retrieval device creation system comprising: a server computer coupled to a network executing stored instructions allowing the server to host a webpage, the server also having access to a database of stored memories accessible by the server; an app operable to load a digital memory into the server and generate a unique scan-able internet directing code for the digital memory to be applied to a memory retrieval device; and a converter for transforming the unique scan-able internet directing code into one or more patterns selected from one or more vertical bars, one or more vertical boxes, one or more vertical rectangles, one or more vertical ovals, and one or more waves, wherein the stored instructions on the server allow a person with the memory retrieval device to retrieve the memory from the database using the pattern. The patterns can be linearly, curvedly, circularly or randomly oriented. Additionally, the unique scan-able internet directing code is a binary code generated from the digital memory. In some configurations, the pattern is selected by a user.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

US 2014/0203085 A1 by Park for QR Code Display Objection, Method of Selling QR Codes Using Same and Method Providing Information Thereof dated Jul. 24, 2014;

US 2018/0322554/A1 by Born et al. for Personalized Gift System and Method dated Nov. 8, 2018;

US 2020/0098028 by DeLuca et al. for Durable Memento Method dated Mar. 26, 2020;

U.S. Pat. No. 8,261,972 B2 by Ziegler for Stand Alone Product, Promotion Product Sample, Container, or Packaging Comprised of Interactive Quick Response (QR Code, MS Tag) or other Scan-able Interactive Code Linked to one or more Internet Uniform Resource Locators (URLs) for Instantly Delivering Wide Band Digital Content, Promotions and Infotainment Brand Engagement Features Between Consumers and Marketers dated Sep. 11, 2012;

U.S. Pat. No. 8,651,370 B1 by Mudrick et al. for System for Providing Coded Personalized Souvenirs dated Feb. 18, 2014;

U.S. Pat. No. 8,881,990 B2 by Hunt et al. for System and Method for Quickly Obtaining Medical Information dated Nov. 11, 2014;

U.S. Pat. No. 9,589,062 B2 by DeLuca et al. for Durable Memento System dated Mar. 7, 2017;

U.S. Pat. No. 9,824,310 B2 by Huynh for Article of Jewelry with Hidden Near Field Communication (NFC) Chip and Metallic Bezel Substantially Surrounding the NFC Chip and Uses Thereof dated Nov. 21, 2017;

U.S. Pat. No. 10,460,371 B2 by DeLuca et al. for Durable Memento Method dated Oct. 29, 2019;

U.S. Pat. No. 10,904,669B2 by Talakoub et al. for System for Presentation of Audio Using Wearable Device dated Jan. 26, 2021;

U.S. Pat. No. 11,064,775 B2 by Nelson for Jewelry Device dated Jul. 20, 2021;

KR 10-1098861 B1 by Park Jewelry with a Quick Response Code Capable of Enabling a User to Confirm all Information on the Jewelry dated Dec. 27, 2011; and

Jain, DIGITAL JEWELRY dated 2015.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1A-1G are exemplar devices with a digital memory retrieval code;

FIGS. 1H-N are exemplar memory retrieval codes;

FIG. 2 is a block diagram showing steps for generating a digital memory retrieval code and associating the memory code with a digital memory;

FIG. 3 is a block diagram of steps for incorporating a digital memory retrieval code in a tangible item;

FIG. 4 is a block diagram of steps for reading a digital memory retrieval code to retrieve a digital memory;

FIG. 5 is a diagram illustrating an environment for components used to create the digital memory retrieval device;

FIGS. 6A-6B illustrate an application landing screen and an application home screen;

FIGS. 7A-7B illustrate an application screen for scanning and an application screen for memory play back;

FIGS. 8A-8B illustrate application screens for a memory box with no memories and with stored memories; and

FIGS. 9A-9B illustrate an application screen for creating an account and logging on to an account.

### DETAILED DESCRIPTION

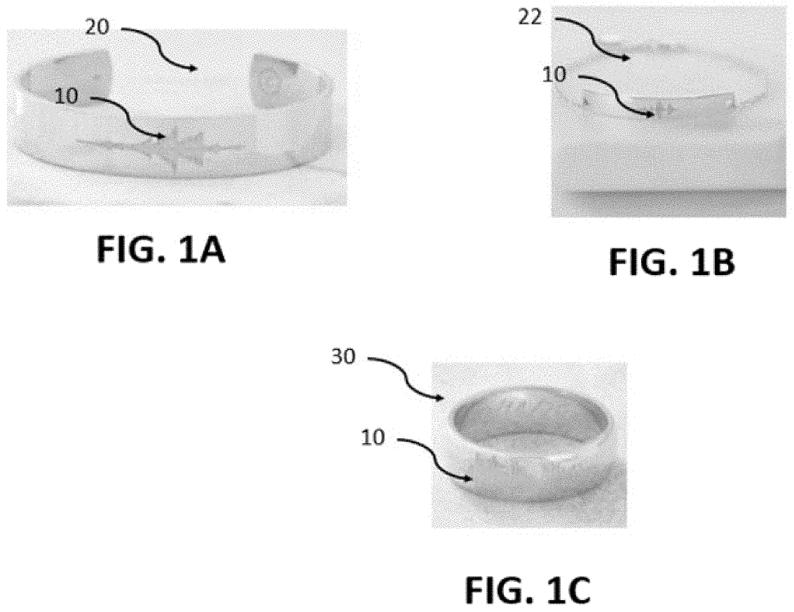

FIGS. 1A-1G are exemplar devices with a digital memory retrieval code. FIGS. 1A-B illustrate bracelets. A cuff-style bracelet 20, as shown in FIG. 1A has a thickness along its length and circumnavigates at least a portion of a wearer's wrist. The thickness allows a digital memory code 10 to be applied to a surface of the cuff-style bracelet 20. The cuff-style bracelet typically has a snug or tight fit around the wearer's wrist. Other bracelet styles include, but are not limited to bangle, chain bracelet, tennis bracelet, charm bracelet, ID style bracelet 22 (shown in FIG. 1B), beaded bracelet etc.

FIG. 1C is a ring 30. The ring 30 is a small circular band sized for wearing around a finger of a user. The ring 30 can be made of any suitable material and include additional ornamentation, such as gemstones. A digital memory code 10 is applied to a surface of the ring.

FIGS. 1D-1F illustrate necklaces 40 having a charm 42 hanging from a chain 44. The charm can be a locket. In FIG. 1D the style of the digital memory code 10 is a series of vertical lines. In FIG. 1E, the style of the digital memory code 10 has the appearance of a soundwave. The digital memory code 10 can be linear, circular, etc. without departing from the scope of the disclosure. The digital memory code 10 can have a length (as illustrated), or could be a series of vertical lines, vertical boxes and/or rectangles, or a wave. FIG. 1F is a horizontal bar style necklace 40.

FIG. 1G is a keychain 50 with a digital memory code 10 on a surface thereof.

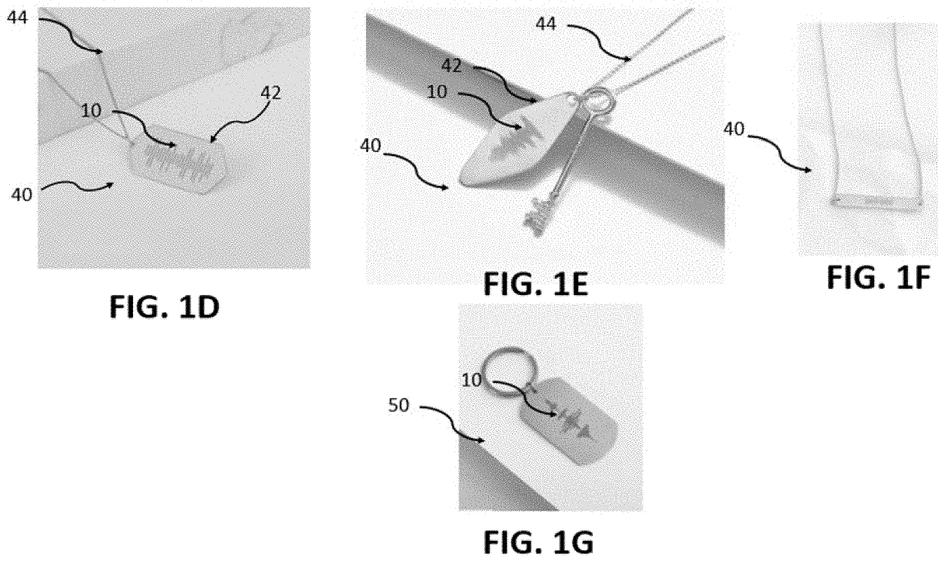

Turning now to the block diagram in FIG. 2, the application (or “app”) starts 100. In this process, once the application starts 100, the app can obtain a digital memory 110. Obtaining the digital memory can be via a file accessible by the app or via, for example, a camera or microphone in communication with the app. The block diagram shows steps for generating a digital memory code from the obtained digital memory. Suitable digital memories include photos, video clips, audio clips, etc. The digital memory can also include a link to a website, e.g., a website with a favorite movie, a favorite song, or a clip from a concert experience.

FIGS. 1H-1N illustrate exemplar memory retrieval codes 10. The code can be a series of lines of different lengths adjacent one another and centrally aligned as shown in FIG. 1H, or aligned at the top as shown in FIG. 1I, or along a curve as shown in FIG. 1J. Other alignments or organizations of lines can be used without departing from the scope of the disclosure. A series of rectangular boxes (outlines or solid) can be organized in an overlapping orientation as shown in FIGS. 1K-iL. A series of circles as shown in FIG. 1M can be used. Similarly the series could be boxes, ovals, triangles, or a combinations of shapes that are aligned across a middle, a top, a bottom, a curve, a circle, an oval, or random. FIG. 1N illustrates a sound wave shaped memory retrieval code. The sound wave shaped code can also be orientated, for example, around a circle.

Turning now to FIG. 2, once the user identifies the digital memory that is to be captured, the app generates a unique digital memory code 120. The unique digital memory code can be any suitable code which can be scanned at a later date and used to retrieve the digital memory. The unique digital memory code can be unique to a particular digital memory, can be unique to a set of memories or can be unique to a file location. The unique digital memory code is a unique fanciful graphic image that functions like a QR code when scanned using computer vision technology to automate visual understanding from the unique digital code with the use of artificial intelligence (AI) and machine learning (ML) algorithms.

In one configuration, the digital memory code can be generated by, for example, associating a binary code with a digital memory, and then converting the binary code into a pattern such as a pattern of long and short overlapping and/or adjacent rectangles, squares, circles, triangles, and/or ovals. The system binary code then operates as a file location identifier used to retrieve the digital memory file from an internet accessible location, such as a server accessible via the internet or a mobile device using the app to translate the pattern back into the binary code to identify the location of the digital memory and access the memory. The only information that needs to be stored in the digital memory code is the binary code which corresponds to a file location for the digital memory.

In another configuration, the digital memory generates a unique binary code and the user is allowed to select a unique pattern to correspond to the unique binary code. Before assigning a unique binary code to a digital memory, the system checks a catalog, list or database of existing binary codes and/or patterns to confirm the binary code and/or the pattern to be assigned to the digital memory is unique in the system prior to finally assigning the binary code and/or pattern to the digital memory.

The digital memory is accessible by scanning the pattern associated with the digital memory code associated on the physical object using an app configured to convert the pattern into the binary code which identifies the file location where the digital memory is stored and internet accessible. The unique digital memory code and/or pattern can be applied to a plurality of physical items. Thus, a plurality of items can have the same unique digital memory code and/or pattern, or a single item can have the unique digital memory code and/or pattern.

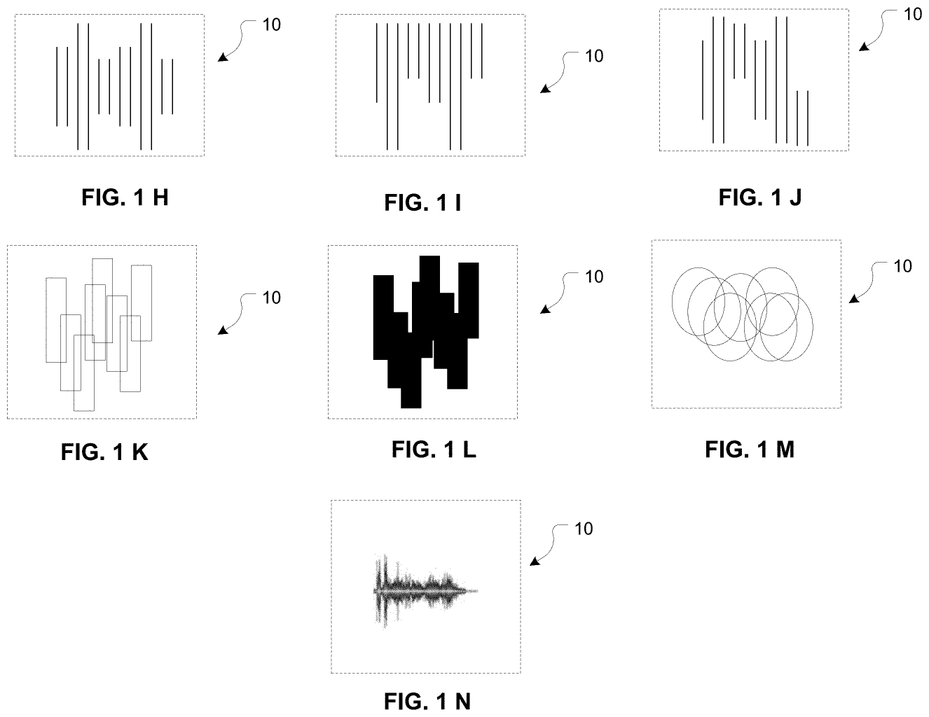

FIG. 3 is a block diagram of steps for incorporating a digital memory retrieval code into a tangible item. The user starts the app 200 and then selects a digital memory 210 (or set of memories). Once the digital memory is selected, the app retrieves the digital memory associated with the digital memory code, or set of memories. The user then selects a tangible item 220 for the digital memory code. From there a tangible item is created with the digital memory code applied 230 during the manufacturing process. The tangible item can, once created, be sent to the user or to a recipient. Neither the digital memory code nor the binary code contain information about the creator of the digital memory code or the recipient of the digital memory code. The digital memory code merely provides a mechanism via the binary code to retrieve the unique memory from an internet accessible location.

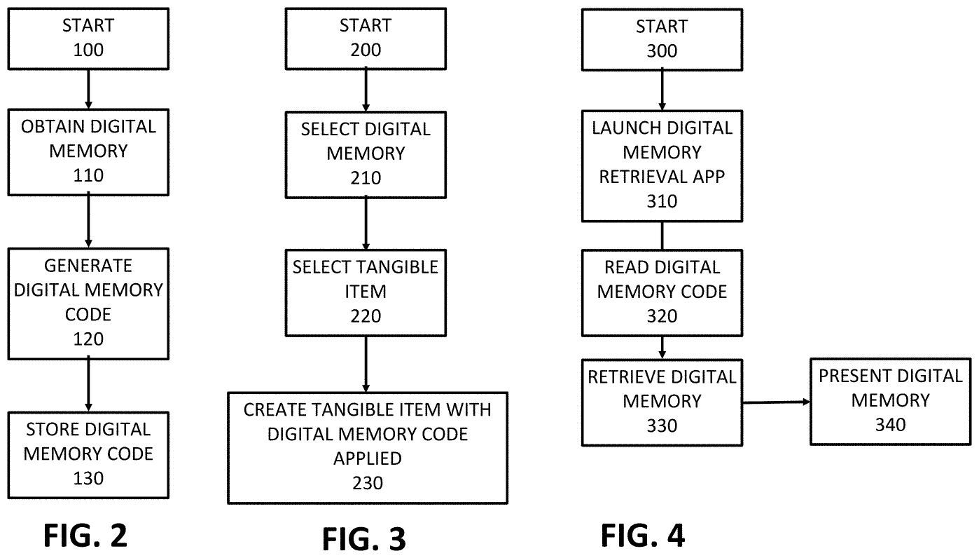

FIG. 4 is a block diagram of steps for reading a digital memory code from a tangible item created in FIG. 3 to retrieve a digital memory. From a start 300 position, a digital memory retrieval app is launched 310. The app instructs the user to position the digital memory code in a manner which allows acquisition. For example, using a camera feature of an electronic device to take a picture of the digital memory code for processing by the app by correlating the digital memory code to a binary code which is used to identify an internet accessible location from which to retrieve the associated digital memory. Once the digital memory code is acquired by the app, the app reads the digital memory code 320 and retrieves the digital memory 330. The digital memory can then be presented on a screen to the user 340 or provided by a link which is sent to another person.

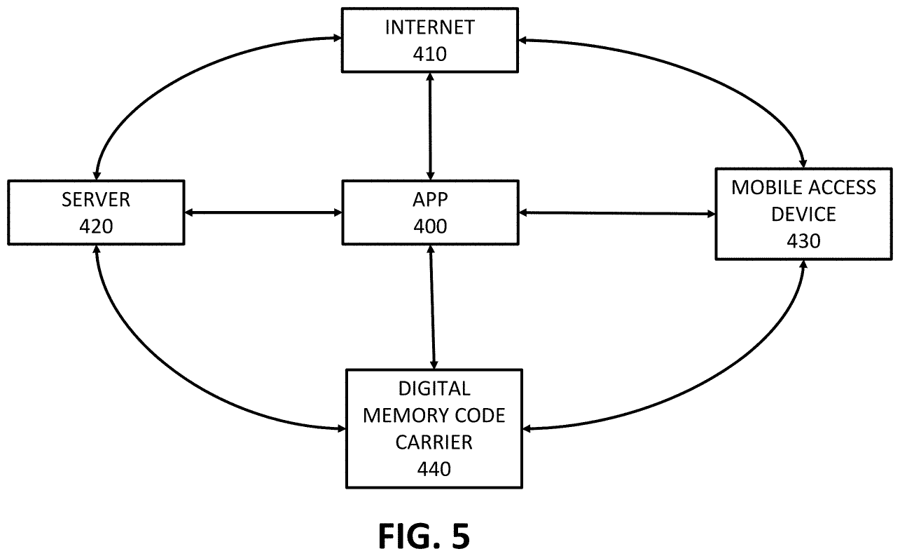

FIG. 5 is a diagram illustrating an operating environment for components used to create the digital memory retrieval device. An app 400 is in communication with the internet 410, e.g. via a mobile network or WiFi connection. The app also communicates with a server 420. Communication with the server can be via the internet. The server also communicates with a mobile access device 430 which may have the app installed. Once the digital memory code has been retrievably associated with an item, the item can act as a digital memory code carrier 440.

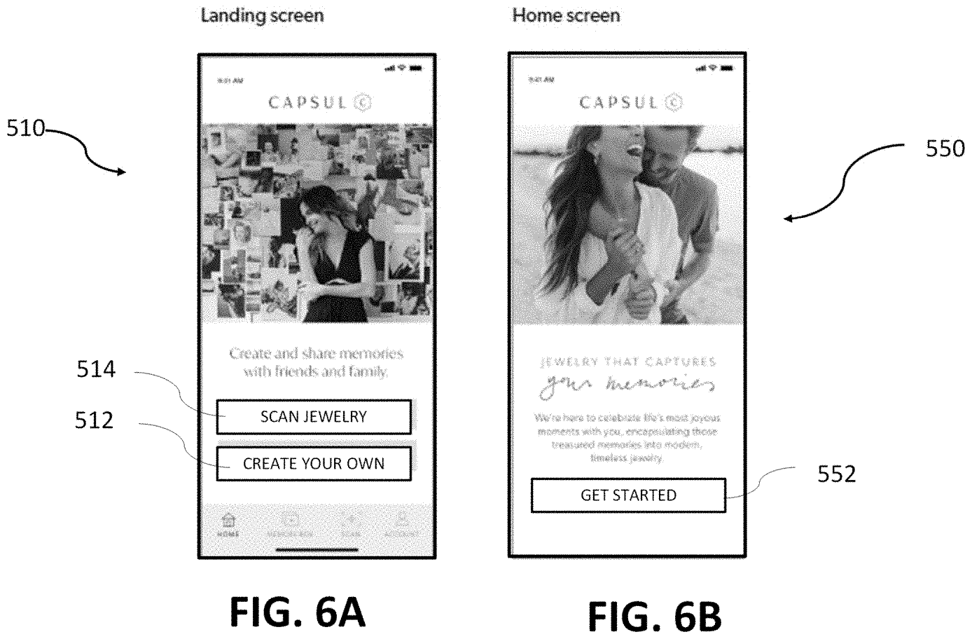

FIGS. 6A-6B illustrate an application landing screen 510 and an application home screen 550 on an electronic device, such as a smart phone or a tablet. The electronic device, for example a circuit board, an antenna, a display, an input device (such as a touch screen or keyboard), a speaker, and a power supply. Additional input devices, such as a camera or scanner can be provided as well. From the application landing screen 510, the user can create a new tangible item 512 or can scan an existing digital memory code 514 by, for example, scanning a code imprinted on a piece of jewelry. From the application home screen 550, the user can proceed via a get started button 552.

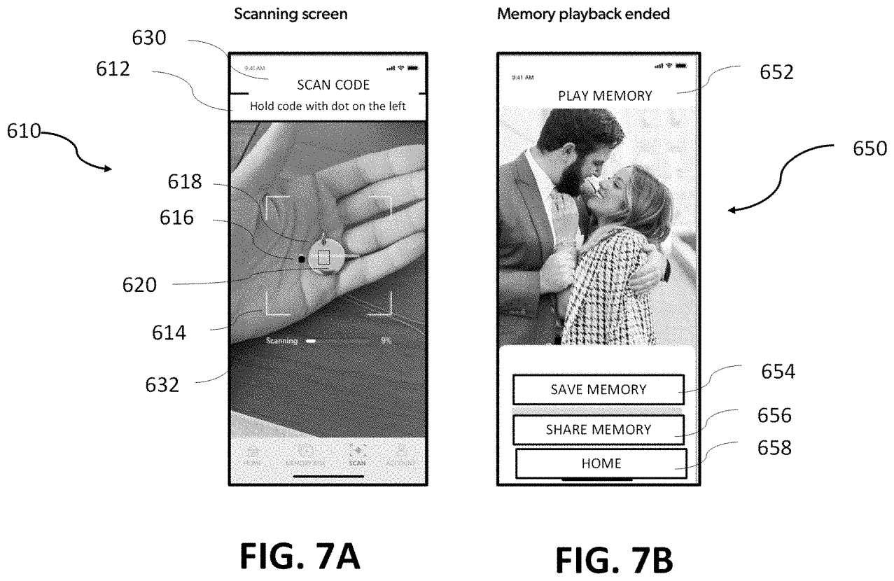

FIGS. 7A-7B illustrate an application scanning interface 610 and for memory play back interface 650. The application scanning interface 610 (i.e., graphical user interface (GUI)) activates code reading functionality or hardware in the electronic device, e.g., camera. Instructions 612 are provided such as “hold code with dot on left”. The tangible item 618 having a visible code 621 is then positioned within a target window 614 of the camera view. The target window 614 can have site lines (as shown) to guide the user in positioning the tangible item 618 so that the digital memory retrieval code 620 is viewable. Once the user instructs the app to scan 630 the digital memory retrieval code, a status indicator 632 can be provided which allows the user to determine the status of the scanning process. Once the memory is retrieved via the memory play back interface 650, the user can access the memory, e.g., play the memory 652 or see the memory. The memory can be saved 654, or remain saved, or shared 656. The user can also navigate back to a home page 658.

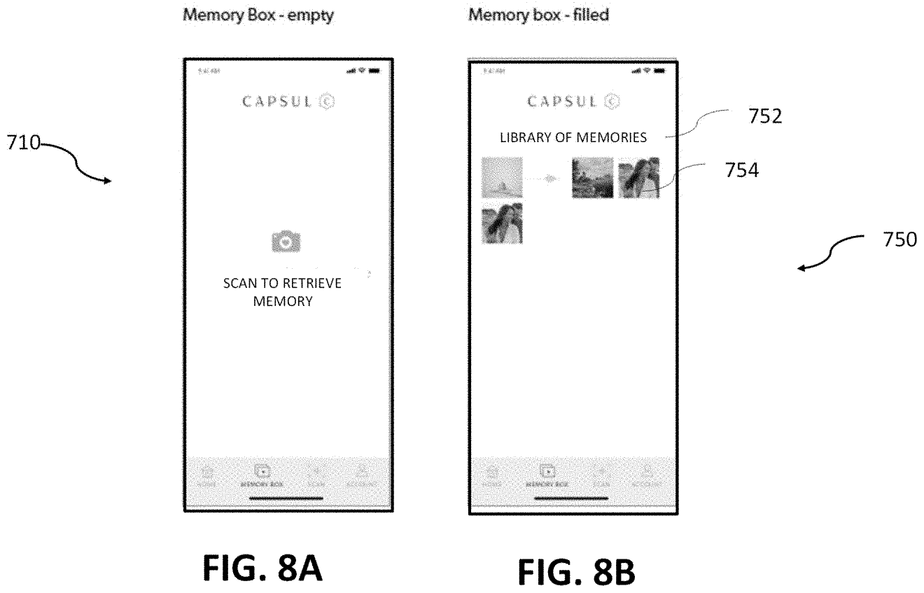

FIGS. 8A-8B illustrate application screens for a memory box with no memories 710 and with stored memories 750. The memory box can have a library of memories 752 which are represented by thumbnail images 754.

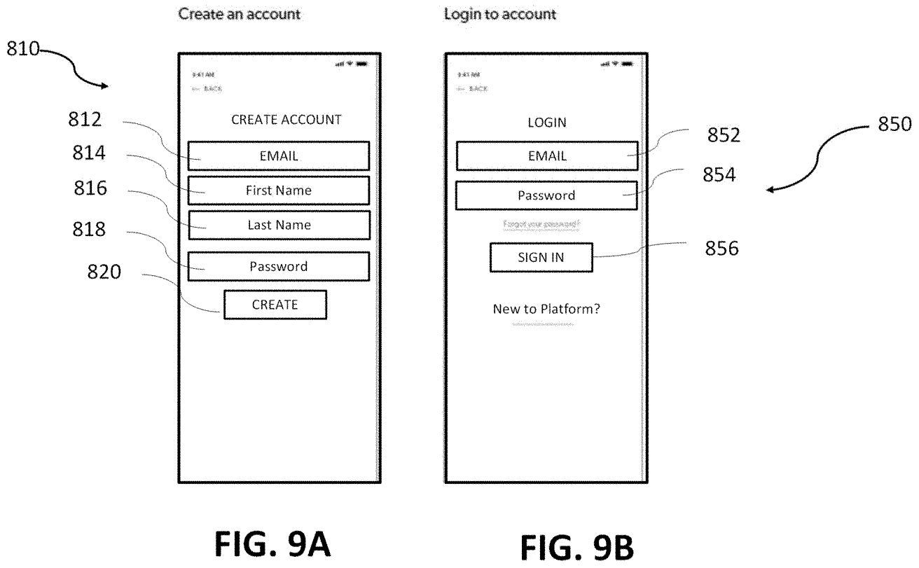

FIGS. 9A-9B illustrate application screens for creating an account 810 and logging on 850. To create an account, a user provides an identifier such as email 812, a first name 814, a last name 816, and a password. Other identifiers can be used, such as mobile phone number, without departing from the scope of the disclosure. Once the account set-up information is provided, the user creates 820 the account. Once the account has been set-up, the user can access information from the login page 850 by providing the account email 852 and password 854. From there, the user signs-in 856. Other authentication methods can also be used, e.g., fingerprint or other biometric data without departing from the scope of the disclosure.

In engaging the systems and methods according to aspects of the disclosed subject matter a user may engage in one or more use sessions. A use session may include a training session for the user.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as flash memory or hard drives)) and executed on a computer (e.g., any device capable of a computing function that includes computing hardware). As will be appreciated by those skilled in the art, computer-readable storage media does not include communication connections, such as modulated data signals. Any of the computer-executable instructions for implementing the disclosed techniques, as well as any data created and used during implementation of the disclosed embodiments, can be stored on one or more computer-readable media (e.g., non-transitory computer-readable media, which excludes propagated signals).

Additionally, the computer-executable instructions can be part of, for example, a dedicated software product or software application (“app”) or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

Only selected aspects of the software-based implementations are described. Other details that are well known in the art are omitted. For example, it should be understood that the disclosed technology is not limited to any specific computer language or program. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means, methods and systems. Such suitable communication means include, for example, the internet, the world wide web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub-combinations with one another. The disclosed methods, apparatus, and systems are not limited to any specific aspect or feature or combination thereof, nor do the disclosed embodiments require that any one or more specific advantages be present or problems be solved.

The instructions may be stored on a suitable “machine readable medium” within a computing device or in communication with or otherwise accessible to the computing device. As used in the present application a machine readable medium is a tangible storage device and the instructions are stored in a non-transitory way. At the same time, during operation, the instructions may at times be transitory, e.g., in transit from a remote storage device to a computing device over a communication link. However, when the machine readable medium is tangible and non-transitory, the instructions will be stored, for at least some period of time, in a memory storage device, such as a random access memory (RAM), read only memory (ROM), a magnetic or optical disc storage device, or the like, arrays and/or combinations of which may form a local cache memory, e.g., residing on a processor integrated circuit, a local main memory, e.g., housed within an enclosure for a processor of a computing device, a local electronic or disc hard drive, a remote storage location connected to a local server or a remote server access over a network, or the like. When so stored, the software will constitute a “machine readable medium,” that is both tangible and stores the instructions in a non-transitory form. At a minimum, therefore, the machine readable medium storing instructions for execution on an associated computing device will be “tangible” and “non-transitory” at the time of execution of instructions by a processor of a computing device and when the instructions are being stored for subsequent access by a computing device.

As will be appreciated by those skilled in the art, the systems and methods disclosed are configurable to send a variety of messages when alerts are generated. Messages include, for example, SMS and email.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the claims define the scope of the invention and that methods and structures within the scope of these claims and their equivalents be covered thereby.

What is claimed:

1. A memory retrieval device comprising:
a device selected from the group comprising necklace, locket, bracelet, earrings, ring and keychain; and
a unique scan-able internet directing code operable to link to a website or web page including a digital memory selected from: (i) photographic, (ii) video, and (iii) audio,
wherein the unique scan-able internet directing code is converted into one or more patterns selected from one or more vertical bars, one or more overlapping boxes, one or more overlapping rectangles, one or more overlapping pentagons, one or more overlapping hexagons, one or more overlapping octagons, one or more overlapping stars, one or more overlapping ovals, one or more overlapping circles, one or more overlapping triangles, and one or more waves,
further wherein the one or more patterns is applied to, affixed to, molded in, or embossed on at least one surface of the device.

2. The memory retrieval device of claim 1 wherein the patterns are linearly, curvedly, circularly or randomly oriented.

3. The memory retrieval device of claim 1 wherein the pattern corresponds to a binary code generated from the digital memory.

4. The memory retrieval device of claim 1 wherein the pattern is selected by a user.

5. The memory retrieval device of claim 1 wherein the one or more vertical bars, one or more overlapping boxes, one or more overlapping rectangles, one or more overlapping pentagons, one or more overlapping hexagons, one or more overlapping octagons, one or more overlapping stars, one or more overlapping ovals, one or more overlapping circles, one or more overlapping triangles have different heights in at least one dimension.

6. The memory retrieval device of claim 1 further comprising a second unique scan-able internet directing code linking to a second website or web page including a second digital memory selected from: (i) photographic, (ii) video, and (iii) audio, wherein the second unique scan-able internet directing code is applied to, affixed to, molded in, or embossed on at least one surface of the device different than the surface of the first unique scan-able internet directing code and the second unique scan-able internet directing code is created for the second digital memory,
further wherein the second unique scan-able internet directing code is converted into one or more second patterns selected from one or more vertical bars, one or more vertical boxes, one or more vertical rectangles, one or more vertical ovals, and one or more waves.

7. The memory retrieval device of claim 6 wherein the second pattern are is linearly, curvedly, circularly or randomly oriented.

8. The memory retrieval device of claim 6 wherein the second unique scanable internet directing code is a second binary code generated from the second digital memory.

9. The memory retrieval device of claim 8 wherein the second pattern is selected by a user.

10. A memory retrieval method comprising:
selecting one digital memory from: (i) photographic memories, (ii) video memories, and (iii) audio memories;
creating a unique scan-able internet directing code for the one digital memory;
converting the unique scan-able internet directing code into one or more patterns selected from one or more vertical bars, one or more vertical boxes, one or more vertical rectangles, one or more vertical ovals, and one or more waves;
selecting a memory retrieval device from the group comprising necklace, locket, bracelet, earrings, ring and keychain; and
applying the pattern to a surface of the memory retrieval device.

11. The memory retrieval method of claim 10 further comprising obtaining the code from the memory retrieval device using an internet connected electronic device.

12. The memory retrieval method of claim 10 further comprising the step of selecting the one or more patterns.

13. A memory retrieval device system comprising:
a server computer coupled to a network executing stored instructions allowing the server to host a webpage, the server also having access to a database of stored memories accessible by the server;
a digital memory;
a unique scan-able internet directing code for the digital memory;
a converter for transforming the unique scan-able internet directing code into one or more patterns selected from one or more vertical bars, one or more overlapping boxes, one or more overlapping rectangles, one or more overlapping pentagons, one or more overlapping hexagons, one or more overlapping octagons, one or more overlapping stars, one or more overlapping ovals, one or more overlapping circles, one or more overlapping triangles, and one or more waves; and
a memory retrieval device having a pattern affixed thereto,
wherein the stored instructions on the server allow a person with a memory retrieval device to retrieve the memory from the database using the pattern.

14. The memory retrieval device system of claim 13 wherein the patterns are linearly, curvedly, circularly or randomly oriented.

15. The memory retrieval method of claim 13 wherein the unique scan-able internet directing code is a binary code generated from the digital memory.

16. The memory retrieval method of claim 13 wherein the pattern is selected by a user.

17. A memory retrieval device creation system comprising:
a server computer coupled to a network executing stored instructions allowing the server to host a webpage, the server also having access to a database of stored memories accessible by the server;
an app operable to load a digital memory into the server and generate a unique scan-able internet directing code for the digital memory to be applied to a memory retrieval device; and
a converter for transforming the unique scan-able internet directing code into one or more patterns selected from one or more vertical bars, one or more vertical boxes, one or more vertical rectangles, one or more vertical ovals, and one or more waves,
wherein the stored instructions on the server allow a person with the memory retrieval device to retrieve the memory from the database using the pattern.

18. The memory retrieval device creation system of claim 17 wherein the patterns are linearly, curvedly, circularly or randomly oriented.

19. The memory retrieval device creation system of claim 17 wherein the unique scan-able internet directing code is a binary code generated from the digital memory.

20. The memory retrieval device creation system of claim 17 wherein the pattern is selected by a user.
